(19) United States
(12) Patent Application Publication
(10) Pub. No.: US 2007/0096529 A1
(43) Pub. Date: May 3, 2007

(54) Recliner apparatus for vehicle seat

(75) Inventors: Yasuhiro Kojima, Kariya-shi (JP); Hideo Nihonmatsu, Anjo-shi (JP)

Correspondence Address: BUCHANAN, INGERSOLL & ROONEY PC, POST OFFICE BOX 1404, ALEXANDRIA, VA, 22313-1404, US

(73) Assignee: Aisin Seiki Kabushiki Kaisha, Kariya-shi (JP)

(21) Appl. No.: 11/545,549

(22) Filed: Oct. 11, 2006

(30) Foreign Application Priority Data
Oct. 31, 2005 (JP) 2005-315603

(51) Int. Cl. B60N 2/02

(52) U.S. Cl. 297/366

(57) ABSTRACT

A recliner apparatus for a vehicle seat having a seat cushion and a seat back includes a first member attached to the seat cushion side, a second member attached to the seat back side and relatively rotatable to the first member, a return spring for biasing the seat back forward or backward relative to the seat cushion and a clutch mechanism provided between the first member and the second member and operated by centrifugal force action concurrent with a rotational operation of the second member for giving rotational resistance to the second member.

### CROSS REFERENCE TO RELATED APPLICATIONS

This application is based on and claims priority under 35 U.S.C. § 119 to Japanese Patent Application 2005-315603, filed on Oct. 31, 2005, the entire content of which is incorporated herein by reference.

### FIELD OF THE INVENTION

This invention generally relates to a recliner apparatus for a vehicle seat. More specifically, this invention pertains to a recliner apparatus for a vehicle seat for supporting a seat back to a seat cushion so that an angle between the seat back and the seat cushion can be adjusted.

### BACKGROUND

Generally, a recliner apparatus for a vehicle seat has an advantage that a seat back can be fixed quickly at an arbitrary angle position because the seat back automatically returns by virtue of a return spring. However, problem may occur in that the seat back strongly collides with an occupant as the seat back quickly pulls back, which results in an uncomfortable feeling to the occupant.

For overcoming this, for example, as described in JPH7 (1995)-137564A (Patent document 1) or in JPH9 (1997)-252868A (Patent document 2), various kinds of recliner apparatuses for vehicle seats, in which returning speed of a seat back is slow, are suggested. In Patent document 1, for reducing rising speed of a seat back, the seat back is rotated while an end portion of a leaf spring included in a clutch case is elastically deformed in a direction in which a diameter thereof is enlarged to lock a seat back, and in turn while an opposite end of the leaf spring is elastically deformed in a direction in which a diameter thereof is reduced. By repeating this, the seat back tilts forward while appropriate braking is applied. On the other hand, in a recliner apparatus for a vehicle seat according to Patent document 2, for reducing rising speed of a seat back, a coil spring is provided in a drum-shaped cover to bias the seat back in an opposite direction of a return spring provided for rising the seat back. As the seat back rises, because a diameter of the coil spring is enlarged toward an inner wall of the cover, rising speed of the seat back becomes gradually slow by frictional resistance between the coil spring and the cover.

In the recliner apparatus for the vehicle seat described in Patent document 1 described above, because lock and rotation is repeated for applying braking to the seat back to reduce the rising speed, the seat back moves awkwardly in an actual operation. Accordingly, an occupant may feel uncomfortable while using the recliner apparatus. Further, an apparatus added for braking the seat back to reduce rising speed functions also in a situation where an occupant conducts a normal adjustment of an angle of the seat back. Accordingly, resistance is applied while the leaf spring is taken along with the seat back even though the diameter thereof is reduced. On the other hand, the seat back is raised while rising torque is smaller than load applied to the recliner apparatus because the seat back does not accelerate while rising. By these reasons, there is a problem that adjustment cannot be performed well.

Further, in the recliner apparatus for the vehicle seat described in Patent document 2 described above, for reducing rising speed of the seat back, the diameter of the spring in the cover is enlarged. Accordingly, for reducing a speed of the seat back accelerated from a near full-flat position, sufficient resistance need to be generated (the diameter of the spring need to be sufficiently enlarged) in a normal-use range. However, an inconvenience may occur in that the seat does not rise when an occupant intends to adjust an angle of the seat back in the normal-use range because of the resistance, and adjustment of the seat cannot be performed well.

A need thus exists for a recliner apparatus for a vehicle seat, which has a clutch mechanism operated by centrifugal force to reduce operational speed of a seat back. The present invention has been made in view of the above circumstances and provides such a recliner apparatus for a vehicle seat.

### SUMMARY OF THE INVENTION

According to an aspect of the present invention, a recliner apparatus for a vehicle seat having a seat cushion and a seat back includes a first member attached to the seat cushion side, a second member attached to the seat back side and relatively rotatable to the first member, a return spring for biasing the seat back forward or backward relative to the seat cushion and a clutch mechanism provided between the first member and the second member and operated by centrifugal force action concurrent with a rotational operation of the second member for giving rotational resistance to the second member.

### BRIEF DESCRIPTION OF THE DRAWINGS

The foregoing and additional features and characteristics of the present invention will become more apparent from the following detailed description considered with reference to the accompanying drawings, wherein:

FIG. 1 represents a diagram illustrating a seat for a vehicle;

FIG. 2 represents a cross-sectional view illustrating a recliner apparatus for a vehicle seat according to a first embodiment of the present invention;

FIG. 3 represents a cross-sectional view taken on line III-III of FIG. 2;

FIG. 4 represents a cross-sectional view illustrating a variation of FIG. 3;

FIG. 5 represents a cross-sectional view illustrating another variation of FIG. 3;

FIG. 6 represents a cross-sectional view illustrating a recliner apparatus for a vehicle seat according to a second embodiment of the present invention;

FIG. 7 represents a cross-sectional view taken on line VII-VII of FIG. 6; and

FIG. 8 represents an enlarged cross-sectional view illustrating a part of FIG. 7.

### DETAILED DESCRIPTION

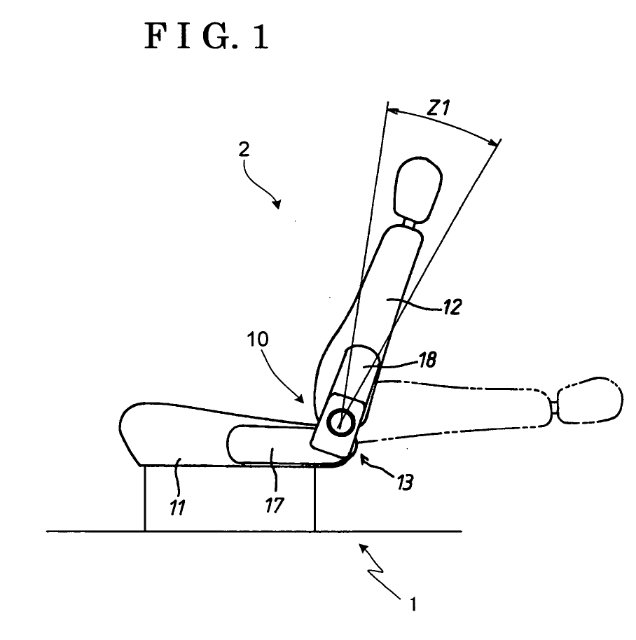

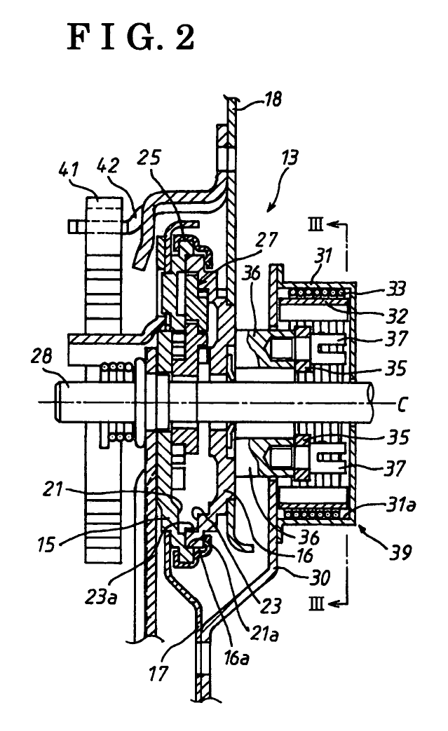

A first embodiment of the present invention will be explained with reference to drawing figures. As illustrated in FIGS. 1 and 2, a recliner apparatus 10 for a vehicle seat 2 for a vehicle 1 includes a seat cushion 11, a seat back 12 and a reclining adjustment mechanism 13 for adjusting an inclination of the seat back 12 relative to the seat cushion 11 in accordance with occupant's preference.

The reclining adjustment mechanism 13 includes a disk-shaped lower arm 15 and a disk-shaped upper arm 16. The upper arm 16 is fitted to the lower arm 15 and is rotatable relative to the lower arm 15. The lower arm 15 is fixed to a seat cushion frame 17 attached to the seat cushion 11 by welding, or the like. The upper arm 16 is fixed to a seat back frame 18 attached to the seat back 12 by welding, or the like.

In the meantime, at least one of the lower arm 15 and the seat cushion frame 17 serves as a first member. At least one of the upper arm 16 and the seat back frame 18 serves as a second member.

A recessed portion 21 is formed at the lower arm 15 by half die cutting so that the recessed portion 21 opens to the upper arm 16 side. The recessed portion 21 includes an inner peripheral surface 21a of which a center is a rotational axis line C of the upper arm 16 and the lower arm 15. The upper arm 16 is fitted to the lower arm 15 so that an outer peripheral surface 16a of the upper arm 16 slides along the inner peripheral surface 21a of the lower arm 15. Sliding surfaces of the lower arm 15 and the upper arm 16 function as a shaft and bearing for mutual rotation. On the other hand, a recessed portion 23 is formed at the upper arm 16 by half die cutting so that the recessed portion 23 opens to the lower arm 15 side. Inner teeth 23a are formed at the recessed portion 23 over entire circumference of an inner peripheral portion of which a center is the rotational axis line C.

A ring member 25 is fixed by a rivet so that the ring member 25 covers an outer periphery of the lower arm 15. One side surface of the ring member 25 rotatably supports an outer peripheral portion of the upper arm 16 as if one side surface of the ring member 25 embraces the outer peripheral portion of the upper arm 16. By this, the lower arm 15 and the upper arm 16 are retained in a state where the lower arm 15 and the upper arm 16 are assembled to be relatively rotatable.

A conventional lock mechanism 27 is provided in the recessed portions 21 and 23 of the lower arm 15 and the upper arm 16 for locking the seat back 12 at an adjusted angle position. The lock mechanism 27 mainly includes a pawl including engaging teeth, which engages with/disengages from the inner teeth 23a formed at the lower arm 15, a pawl plate rotated by operation of an operational lever through a rotational axis 28 and a can for engaging/disengaging the pawl with/from the inner teeth 23a by rotation of the pawl plate. The lock mechanism 27 is conventional and described in, for example, JP2003-9978A. Accordingly, detailed explanations thereof will be skipped.

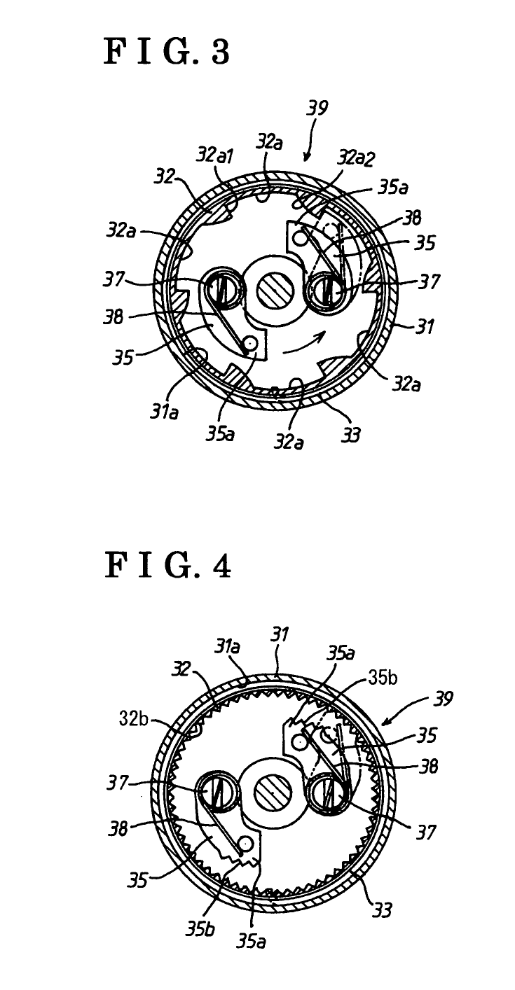

A plate 30 is attached to the seat cushion frame 17 described above so that the plate 30 faces the seat back frame 18. A cylindrical case 31 with a bottom is attached to the plate 30 as a unit. The cylindrical case 31 includes an inner peripheral surface 31a of which a center is the rotational axis line C. As illustrated in FIG. 3, a ring-shaped engaging member 32 is freely rotatably fitted in the cylindrical case 31. A friction spring 33 is wound and provided between an outer peripheral surface of the engaging member 32 and the inner peripheral surface 31a of the cylindrical case 31 along the inner peripheral surface 31a of the cylindrical case 31. One end of the friction spring 33 is bended inwardly in a radial direction and attached to the engaging member 32. The other end of the friction spring 33 is attached to the cylindrical case 31.

The friction spring 33 is inserted into the cylindrical case 31 in a state where the friction spring 33 is contracted to reduce a diameter thereof. The friction spring 33 normally contact the inner peripheral surface 31a of the cylindrical case 31. Accordingly, in a situation where the engaging member 32 rotates in a direction of an arrow illustrated in FIG. 3 (a rotational direction of the seat back frame 18 in a situation where the seat back 12 rises forward), the sliding friction resistance of the friction spring 33 exerts braking force.

Plural engaging recessed portions 32a are formed at an inner periphery of the engaging member 32 at equal angle intervals on a circumference. An engaging end surface 32a1, which is orthogonal to a rotational direction, and an inclined end surface 32a2 are formed at both end portions of each engaging recessed portion 32a in a rotational direction. The engaging end surface 32a1 is located frontward in the direction of the arrow illustrated in FIG. 3, and the inclined end surface 32a2 is located rearward in the direction of the arrow illustrated in FIG. 3.

A supporting block 36 is fixed to the seat back frame 18. The supporting block 36 penetrates the plate 30 and is inserted into the cylindrical case 31. A supporting pin 37 is screwed to the supporting block 36 in parallel with the rotational axis line C. One end of a swing arm 35 is swingably supported by the supporting pin 37. The swing arm 35 functions as a weight member, of which an end portion 35a swings outwardly in a radial direction by centrifugal force generated concurrently with rotational operation of the seat back 18. As illustrated in FIG. 3, two swing arms 35 are provided in the engaging member 32 on a circumference. A torsion spring 38 is fitted to the supporting pin 37. One end of the torsion spring 38 is attached to the supporting pin 37. The other end of the torsion spring 38 is attached to the end portion 35a of the swing arm 35.

The swing arm 35 is normally retained in an angle state where the end portion 35a of the swing arm 35 is retracted inwardly in a radial direction by biasing force of the torsion spring 38. In this state, the swing arm 35 does not contact the inner periphery of the engaging member 32, and the swing arm 35 can freely rotate in the engaging member 32. Then, in a situation where centrifugal force, which is larger than the biasing force of the torsion spring 38, is applied to the swing arm 35, the swing arm 35 is swung so that the end portion 35a of the swing arm 35 swings outwardly in a radial direction around the supporting pin 37 as a supporting point.

By this, the end portion 35a of the swing arm 35 is inserted into the engaging recessed portion 32a of the engaging member 32. Then, at this time, in a situation where the seat back frame 18 is rotating in the direction of the arrow illustrated in FIG. 3, the end portion 35a of the swing arm 35 engages with the engaging end surface 32a1 of the engaging recessed portion 32a. Thus, the engaging member 32 rotates with the swing arm 35. However, in a situation where the seat back frame 18 is rotating in an opposite direction of the arrow illustrated in FIG. 3, the end portion 35a of the swing arm 35 slides along the inclined end surface 32a2 of the engaging recessed portion 32a and leaves therefrom. Thus, the engaging member 32 does not rotate with the swing arm 35.

Accordingly, in a situation where the seat back frame 18 rotates in the direction of the arrow illustrated in FIG. 3, in other words, in a situation where the seat back 12 returns forward, the engaging member 32 rotates in the direction of the arrow with the swing arm 35. Accordingly, sliding resistance of the friction spring 33 exerts braking force to the engaging member 32 and a member rotating with the engaging member 32 as a unit.

A clutch mechanism 39 is configured from above-described cylindrical case 31, the engaging member 32, the friction spring 33, the swing arm 35 and the torsion spring 38, or the like. The clutch mechanism 39 is operated by centrifugal force generated in a situation where the seat back 12 is raised with great force and functions to reduce rising speed of the seat back 12.

A reference number 41 indicates a return spring, of which one end is attached to a bracket 42 fixed to the seat back frame 18. The return spring 41 normally exerts biasing force to the seat back frame 18 in a direction in which the seat back 12 reclines forward. Accordingly, in a situation where a lock of the lock mechanism 27 is released by the operation of the operational lever described above, the seat back 12 returns forward by virtue of the biasing force of the return spring 41.

Next, operation of the recliner apparatus 10 for the vehicle seat 2 according to the first embodiment described above will be explained. In a normal-use region (region of an angle range Z1 illustrated in FIG. 1), in which a tilting angle of the seat back 12 is adjusted in a state where an occupant is seated, because the amount of adjustment of the tilting angle is relatively small, rotational speed of the seat back frame 18 in a situation where the seat back 12 returns forward is low. Accordingly, centrifugal force exerted to the swing arm 35 is small, and the centrifugal force exerted to the swing arm 35 cannot be larger than the biasing force of the torsion spring 38. As a result, the swing arm 35 is retained in a normal angle state, in which the end portion 35a of the swing arm 35 is positioned inwardly in a radial direction by virtue of the biasing force of the torsion spring 38, and the swing arm 35 does not contact the engaging recessed portion 32a of the engaging member 32.

Thus, by the operation for returning the seat back 12 forward by the operational lever, the seat back 12 can quickly return by virtue of the biasing force of the return spring 41, and angle adjustment of the seat back 12 can be quickly performed.

On the other hand, for example, in a situation where the seat back 12 is raised from a full-flat state indicated by a chain double-dashed line in FIG. 1 with great force, because rotational speed of the seat back frame 18 becomes high, centrifugal force, which is larger than the biasing force of the torsion spring 38, is exerted to the swing arm 35. The swing arm 35 is swung around the supporting pin 37 as the supporting point by the centrifugal force action. Then, as indicated by a chain double-dashed line in FIG. 3, the end portion 35a of the swing arm 35 engages with the engaging end surface 32a1 of the engaging recessed portion 32a of the engaging member 32. By this, the engaging member 32 rotates around the rotational axis line C with the swing arm 35. Thus, the swing arm 35 is operationally connected to the friction spring 33 through the engaging member 32. Here, sliding resistance of the friction spring 33 is exerted to the engaging member 32. Therefore, returning speed of the seat back 12 can be reduced by sliding friction of the friction spring 33. Accordingly, strong collision of the seat back 12, which is rapidly rotating to a forward-tilting position, with an occupant, can be prevented with reliability.

In a situation where the centrifugal force becomes small, the swing arm 35 is swung inwardly in a radial direction by the biasing force of the torsion spring 38, and the swing arm 35 is disengaged from the engaging member 32. Accordingly, the seat back 12 can be operated without receiving sliding resistance of the friction spring 33.

In the meantime, in an opposite situation where the seat back 12 is laid with great force, in other words, in a situation where the seat back frame 18 rapidly rotates in an opposite direction of the arrow illustrated in FIG. 3, the swing arm 35 is swung by centrifugal force, and the swing arm 35 comes in contact with an inner surface of the engaging member 32. However, because the swing arm 35 slides along the inclined surface 32a2 of the engaging member 32 and leaves therefrom in the rotational direction of the seat back frame 18, the clutch mechanism 39 is not operated, and the seat back 12 can be operated quickly in a direction in which the seat back 12 is laid. Thus, the clutch 39 has a function as a one-way clutch.

According to the first embodiment described above, the clutch mechanism 39 is operated on the basis of magnitude of centrifugal force exerted to the swing arm 35 generated in accordance with rotational speed of the seat back frame 18. Accordingly, the clutch mechanism 39 is not operated at the time of normal-use by an occupant, and the seat back 12 can return forward without resistance, and an angle adjustment can be performed without uncomfortable feeling.

On the other hand, in a situation where the seat back 12 is raised with great force, because the clutch mechanism 39 is operated on the basis of centrifugal force action exerted to the swing arm 35, sliding resistance between the friction spring 33 and the inner peripheral surface 31a of the cylindrical case 31 reduces rising speed of the seat back 12. By this, strong collision of the seat back 12 with an occupant can be prevented with reliability.

In the meantime, appropriate setting of the swing arm 35 or the torsion spring 38, or the like, which configure the clutch mechanism 39, can reduce speed of the seat back 12 also in a situation where the seat back 12 rises from the normal-use region by relatively short distance. The recliner apparatus for the vehicle seat is not limited to that the clutch mechanism 39 is not operated in the normal-use region. Further, timing of generating sliding resistance by operation of the clutch mechanism 39 can be appropriately set by, for example, adjusting positions or the number of the engaging end surfaces 32a1.

Further, a variation of the first embodiment will be explained. In addition to the engaging member 32 and the swing arm (weight member) 35 described above, another swing arm (weight member), which engages with another engaging member in a situation where the seat back frame 18 rotates in an opposite of the direction described above, can be added to correspond to rapid rotation of the seat back 12 in both forward and backward ways. By this, in a situation where the seat back 12 is pushed backward and laid by hand with great force, or in a situation where an occupant leans back on the seat back 12 by using his/her weight, operational speed of the seat back 12, which exceeds a predetermined speed or acceleration, can be reduced. Accordingly, an occupant can be prevented from a sudden rearward leaning caused by the seat back 12 being rapidly moved backward.

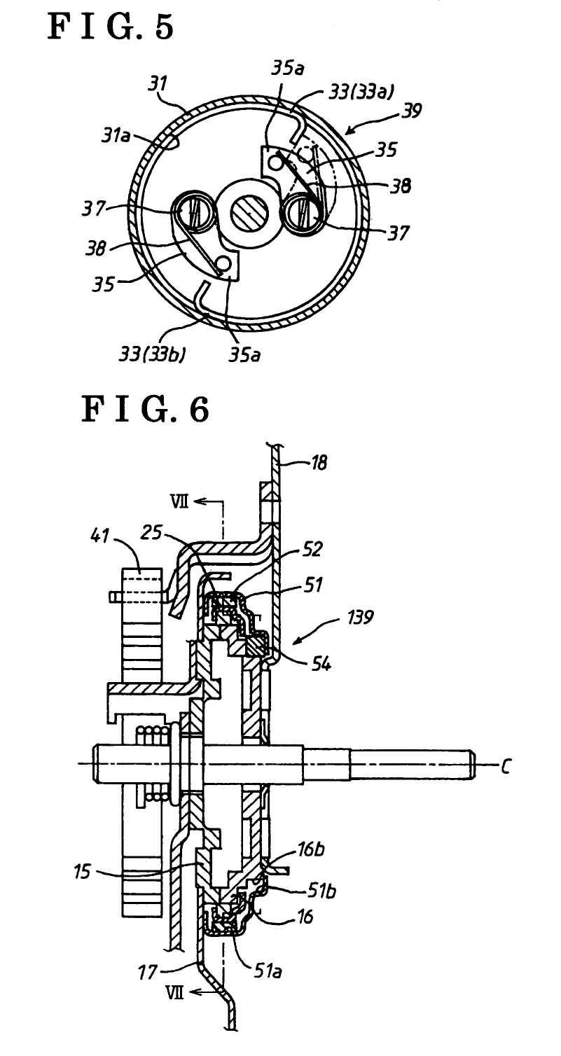

FIGS. 4 and 5 represent diagrams illustrating variations of the clutch mechanism 39. In the clutch mechanism 39 illustrated in FIG. 4, sawtooth inner teeth 32b are formed at an inner peripheral surface of the engaging member 32 freely fitted in the cylindrical case 31, and on the other hand, engaging teeth 35b, which engage with the inner teeth 32b of the engaging member 32 in a situation where the swing arm 35 is swung outwardly in a radial direction by centrifugal force, are formed at the end portion 35a of the swing arm 35. In this variation also, as indicated by a chain double-dashed line illustrated in FIG. 4, in a situation where the engaging teeth 35b of the swing arm 35 engage with the inner teeth 32b of the engaging member 32, the engaging member 32, to which one end of the friction spring 33 is attached, starts rotating with the swing arm 35 as a unit, and sliding friction of the friction spring 33 is exerted.

Further, in the clutch mechanism 39 illustrated in FIG. 5, the engaging member described above is removed, and one-end of the friction spring 33 is extended inwardly in a radial direction so that one end of the friction spring 33 can contact the swing arm 35. By this, in a situation where the swing arm 35 is swung outwardly in a radius direction by centrifugal force, the end portion 35a of the swing arm 35 directly engages with one end of the friction spring 33, and the swing arm 35 is operationally connected to the friction spring 33. In the meantime, in FIG. 5, for reducing play between the swing arm 35 and one end of the friction spring 33 in a rotational direction, two friction springs 33a and 33b, which respectively engage with the swing arms 35, provided at two positions on a circumference, are provided. However, the number of the swing arms 35, or the number of the friction springs 33 can be furthermore increased.

In the meantime, in FIGS. 4 and 5, identical reference numbers are assigned to configuration members identical to those descried in the first embodiment, and explanations thereof will be skipped.

Next, a second embodiment of the present invention will be explained with reference to FIGS. 6, 7 and 8. In a recliner apparatus 10 for a vehicle seat 2 according to the second embodiment, a configuration of a clutch mechanism 139, which is operated in a situation where the seat back 12 is raised with great force, is different from the clutch mechanism 39 in the first embodiment. In the meantime, in FIG. 6, illustration of the lock mechanism provided in the recessed portions of the lower arm 15 and the upper arm 16 are omitted.

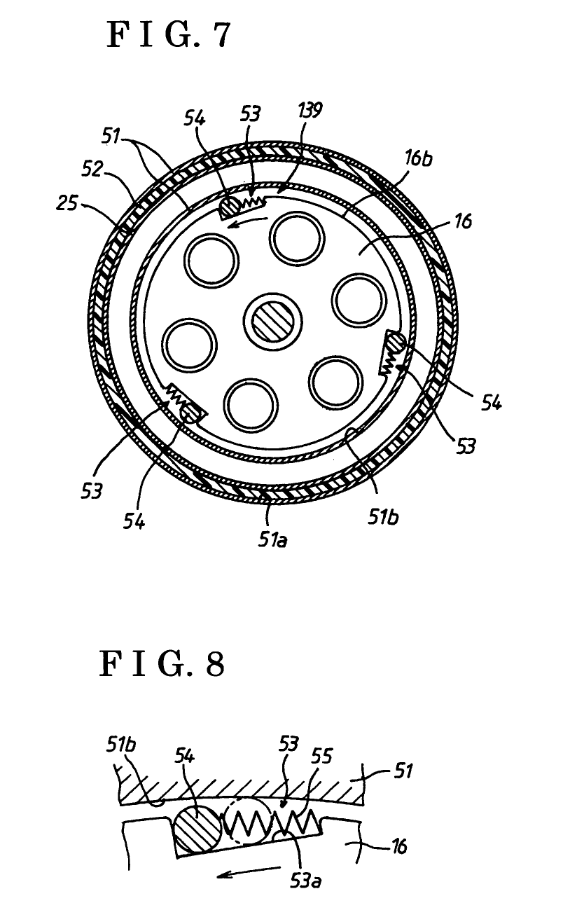

In FIGS. 6 and 7, similarly to the first embodiment described above, the lower arm 15 and the upper arm 16 are assembled and relatively rotatably retained by the ring member 25 fixed by a rivet and provided at the outer periphery of the lower arm 15. A ring-shaped case member 51 is located at an outer periphery of the ring member 25 so that the case member 51 covers the ring member 25. Movement of the case member 51 relative to the ring member 25 in an axial direction is restricted. A first inner peripheral surface 51a, which is freely fitted to an outer peripheral surface of the ring member 25 with a clearance therebetween, and a second inner peripheral surface 51b, which is freely fitted to a stepped outer peripheral surface 16b of the upper arm 16 with a clearance therebetween, are formed at the case member 51.

A sliding resistance member 52 made of, for example, a resin ring, is provided between the first inner peripheral surface 51a of the case member 51 and the outer peripheral surface of the ring member 25. The case member 51 can rotate relative to the ring member 25 with sliding resistance exerted by the sliding resistance member 52. Plural wedge portions 53 are provided at the stepped outer peripheral surface 16b of the upper arm 16, which faces the second inner peripheral surface 51b of the case member 51, to recess on a circumference. As illustrated in FIG. 8 in detail, a wedge surface 53a, which is inclined in a rotational direction, is formed at a bottom surface of each wedge portion 53. By this, depth of each wedge portion 53 gradually increases toward a rotational direction (direction of arrows illustrated in FIGS. 7 and 8) of the upper arm 16 in a situation where the seat back 12 rises forward. A roller bearing 54, which serves as a weight member, is accommodated in each wedge portion 53 so that the roller bearing 54 can move along the wedge surface 53a between a deep position and a shallow position. The roller bearing 54 is pressed toward a rotational direction of the upper arm 16 by biasing force of a coil spring 55. By this, the roller bearing 54 is normally retained at a position where the roller bearing 54 contacts a deep-side end surface of the wedge portion 53.

In a normal state where the roller bearing 54 is positioned at the deep-side end surface of the wedge portion 53, there is a clearance between the roller bearing 54 and the second inner peripheral surface 51b of the case member 51. Accordingly, the upper arm 16 can rotate regardless of the case member 51. However, centrifugal force action in accordance with increase of rotational speed of the upper arm 16 (seat back frame 18) moves the roller bearing 54 along the wedge surface 53a outwardly in a radial direction against the biasing force of the coil spring 55. Then, as indicated by a chain double-dashed line illustrated in FIG. 8, the roller bearing 54 is caught between the second inner peripheral surface 51b of the case member 51 and the wedge surface 53a of the wedge portion 53 of the upper arm 16. As a result, the upper arm 16 and the case member 51 are connected to one another through the roller bearing 54, and rotation of the upper arm 16 is transmitted to the case member 51 through the roller bearing 54. By this, the case member 51 and the upper arm 16 start rotating relatively to the ring member 25 with sliding resistance exerted by the sliding resistance member 52.

The clutch mechanism 139 is configured from the case member 51, the sliding resistance member 52, the wedge portion 53, the roller bearing 54, and the coil spring 55, or the like, which are described above. The clutch mechanism 139 is operated on the basis of centrifugal force generated in a situation where the seat back 12 is raised with great force. The clutch mechanism 139 functions to reduce rising speed of the seat back 12.

The recliner apparatus 10 for the vehicle seat 2 according to the second embodiment is configured as described above. Accordingly, in the normal-use region (region of the angle range Z1 illustrated in FIG. 1), in which the tilting angle of the seat back 12 is adjusted in a state where an occupant is seated, because adjusted angle range is relatively small, rotational speed of the upper arm 16 in a situation where the seat back 12 returns forward is low, and centrifugal force exerted to the roller bearing 54 is small. Therefore, the roller bearing 54 is retained at a position where the roller bearing 54 contacts the deep-side end surface of the wedge portion 53 by virtue of the biasing force of the coil spring 55, and the roller bearing 54 does not contact the second inner peripheral surface 51b of the case member 51.

Accordingly, operation for returning the seat back 12 forward by the operational lever can quickly return the seat back 12 by virtue of the biasing force of the return spring 41, and angle adjustment of the seat back 12 can be quickly performed.

On the other hand, in a situation where the seat back 12 is raised with great force, because rotational speed of the upper arm 16 becomes high, centrifugal force also becomes large. This centrifugal force action moves the roller bearing 54 along the wedge surface 53a outwardly in a radial direction against the biasing force of the coil spring 55. As a result, as indicated by the chain double-dashed line illustrated in FIG. 8, the roller bearing 54 is caught between the second inner peripheral surface 51b of the case member 51 and the wedge surface 53a of the wedge portion 53 of the upper arm 16, and rotation of the upper arm 16 is transmitted to the case member 51 through the roller bearing 54. Accordingly, the case member 51 rotates with the upper arm 16 as a unit. At this time, sliding resistance exerted to the case member 51 by the sliding resistance member 52 reduces returning speed of the seat back 12.

In the meantime, in a situation where the seat back 12 is laid with great force, in other words, in a situation where the upper arm 16 rapidly rotates in an opposite direction of the arrows illustrated in FIGS. 7 and 8, the roller bearing 54 comes in contact with the second inner peripheral surface 51b of the case member 51 by centrifugal force. However, in this rotational direction of the upper arm 16, the roller bearing 54 is not caught between the wedge portion 53 and the case member 51. Accordingly, the case member 51 does not rotate with the upper arm 16 as a unit. Thus, the clutch mechanism 139 has a function as a one-way clutch, similarly to the clutch mechanism 39 described above.

According to the second embodiment described above, similarly to the clutch mechanism 39 described in the first embodiment, the clutch mechanism 139 is operated only in a situation where centrifugal force concurrent with rotational operation of the upper arm 16 (seat back frame 18) is large. The clutch mechanism 139 functions to reduce rising speed of the seat back 12. Further, the recliner apparatus 10 for the vehicle seat 2 can be configured only by locating the clutch mechanism 139 as a unit at an outer peripheral portion of the lower arm 15 in the first embodiment. Accordingly, the cylindrical case 31 in the first embodiment can be removed. Therefore, the clutch mechanism 139 can be located in a small space without restriction from layout, and miniaturization of the recliner apparatus 10 can be possible.

Further, a variation of the second embodiment will be explained. In the variation, in addition to the wedge portion 53 described above, a wedge portion opposite to the wedge portion 53 can be added. Then, a roller bearing, which serves as a weight member, can be accommodated in the opposite wedge portion. By this, countermeasure can be anticipated against both forward and backward rapid rotation of the seat back 12. Accordingly, similar to the description above, an occupant can be inhibited from a sudden rearward leaning caused by the seat back 12 being rapidly moved backward.

In the meantime, in the second embodiment, resistance (sliding friction resistance) was exerted to operation of the seat back 12 by the sliding resistance member 52. However, such a resistance is not limited to sliding friction resistance, but can be exerted by other resistance members, for example, by fluid resistance means, in which shearing resistance of fluid is utilized, or the like.

In the embodiments described above, explanations were made with an example, in which the seat back was biased forward by the return spring. However, the present invention can be applied not only to the seat back, but also to, for example, a seat, which is biased backward, as an arrangement means of a rear seat (a means for making the seat change to a tumbled state by raising a seat cushion forward with a seat back laid forward).

Further, in the embodiments described above, rotational resistance was exerted by the sliding resistance member 52 made of, for example, a resin ring, provided between the case member 51 and the ring member 25. However, a rivet ring of the ring member 25, or the like, which is originally included in a recliner apparatus, may be utilized as a resistance member without separately providing the sliding resistance member, or the like.

As described above, the present invention is not limited to the embodiments described above. Variations can be made without departing from the spirit of the present invention described in the scope of the invention.

According to a first aspect of the present invention, a recliner apparatus for a vehicle seat having a seat cushion and a seat back includes a first member attached to the seat cushion side, a second member attached to the seat back side and relatively rotatable to the first member, a return spring for biasing the seat back forward or backward relative to the seat cushion and a clutch mechanism provided between the first member and the second member and operated by centrifugal force action concurrent with a rotational operation of the second member for giving rotational resistance to the second member.

According to a second aspect of the present invention, in the recliner apparatus for the vehicle seat according to the first aspect, the clutch mechanism includes a friction spring slidable along an inner peripheral surface of a cylindrical case attached to the first member and a weight member accommodated in the cylindrical case and operated by the centrifugal force action concurrent with rotation of the second member and operatively connected to the friction spring.

According to a third aspect of the present invention, in the recliner apparatus for the vehicle seat according to the second aspect, the clutch mechanism includes the friction spring slidable along the inner peripheral surface of the cylindrical case, an engaging member rotatably accommodated in the cylindrical case and engaged with one end of the friction spring and the weight member attached to the second member and engaged with the engaging member by the centrifugal force action.

According to a fourth aspect of the present invention, in the recliner apparatus for the vehicle seat according to the first aspect, the clutch mechanism includes a case member rotatable relative to the first member, a resistance portion for exerting rotational resistance between the case member and the first member and a weight member accommodated in a wedge portion provided at the second member and engaged with the case member by the centrifugal force action.

According to a fifth aspect of the present invention, in the recliner apparatus for the vehicle seat according to any one of the first aspect to the fourth aspect, the clutch mechanism has a one-way clutch function for giving rotational resistance to the second member only in a situation where the clutch mechanism is operated in a direction in which the seat back returns forward.

According to the first aspect of the present invention, rotational resistance is given to the second member by the clutch mechanism located between the first member and the second member and operated on the basis of the centrifugal force action concurrent with the rotational operation of the second member. Accordingly, operational speed of the seat back can be reduced only in a situation where the clutch mechanism is operated by the centrifugal force action. Therefore, accidental situation caused by rapid operation of the seat back can be inhibited. Further, at the time of normal use of the seat back, the clutch mechanism is not operated. Therefore, the seat back can be operated without resistance, and angle adjustment can be performed without uncomfortable feeling.

According to the second aspect of the present invention, the clutch mechanism includes the friction spring, slidable along the inner peripheral surface of the cylindrical case attached to the first member and the weight member accommodated in the cylindrical case and operated by the centrifugal force action and operationally connected to the friction spring. Accordingly, operation of the weight member by the centrifugal force action can reduce the operational speed of the seat back by sliding friction resistance of the friction spring.

According to the third aspect of the present invention, the clutch mechanism includes the friction spring slidable along the inner peripheral surface of the cylindrical case, the engaging member rotatably accommodated in the cylindrical case and engaged with one end of the friction spring and the weight member attached to the second member and engaged with the engaging member by the centrifugal force action. Accordingly, effects similar to the second aspect can be obtained, and the sliding friction resistance of the friction spring can be stably exerted by virtue of the engaging member.

According to the fourth aspect of the present invention, the clutch mechanism includes the case member relatively rotatable to the first member, the resistance portion for exerting rotational resistance between the case member and the first member and the weight member accommodated in the wedge portion provided at the second member and engaged with the case member by the centrifugal force action. Accordingly, the clutch mechanism can be provided without restriction from layout, the clutch mechanism can be located in a small space and miniaturization of the recliner apparatus can be possible.

According to the fifth aspect of the present invention, the clutch mechanism has a one-way clutch function, which gives rotational resistance to the second member only in a situation where the seat back is operated in a direction in which the seat back returns forward. Accordingly, the operational speed is reduced only in an operation in a direction in which the seat back rises, and exertion of rotational resistance can be prevented in a direction in which the seat back is laid.

The principles, preferred embodiment and mode of operation of the present invention, have been described in the foregoing specification. However, the invention that is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A recliner apparatus for a vehicle seat having a seat cushion and a seat back, comprising:
a first member attached to the seat cushion side;
a second member attached to the seat back side and relatively rotatable to the first member;
a return spring for biasing the seat back forward or backward relative to the seat cushion; and
a clutch mechanism provided between the first member and the second member and operated by centrifugal force action concurrent with a rotational operation of the second member for giving rotational resistance to the second member.

2. The recliner apparatus for the vehicle seat according to claim 1, wherein
the clutch mechanism includes a friction spring slidable along an inner peripheral surface of a cylindrical case attached to the first member and a weight member accommodated, in the cylindrical case and operated by the centrifugal force action concurrent with rotation of the second member and operatively connected to the friction spring.

3. The recliner apparatus for the vehicle seat according to claim 2, wherein
the clutch mechanism includes the friction spring slidable along the inner peripheral surface of the cylindrical case, an engaging member rotatably accommodated in the cylindrical case and engaged with one end of the friction spring and the weight member attached to the second member and engaged with the engaging member by the centrifugal force action.

4. The recliner apparatus for the vehicle seat according to claim 1, wherein
the clutch mechanism includes a case member rotatable relative to the first member, a resistance portion for exerting rotational resistance between the case member and the first member and a weight member accommodated in a wedge portion provided at the second member and engaged with the case member by the centrifugal force action.

5. The recliner apparatus for the vehicle seat according to claim 1, wherein
the clutch mechanism has a one-way clutch function for giving rotational resistance to the second member only in a situation where the clutch mechanism is operated in a direction in which the seat back returns forward.

6. The recliner apparatus for the vehicle seat according to claim 2, wherein
the clutch mechanism has a one-way clutch function for giving rotational resistance to the second member only in a situation where the clutch mechanism is operated in a direction in which the seat back returns forward.

7. The recliner apparatus for the vehicle seat according to claim 3, wherein
the clutch mechanism has a one-way clutch function for giving rotational resistance to the second member only in a situation where the clutch mechanism is operated in a direction in which the seat back returns forward.

8. The recliner apparatus for the vehicle seat according to claim 4, wherein
the clutch mechanism has a one-way clutch function for giving rotational resistance to the second member only in a situation where the clutch mechanism is operated in a direction in which the seat back returns forward.
